(19) United States
(12) Patent Application Publication
(10) Pub. No.: US 2020/0111202 A1
(43) Pub. Date: Apr. 9, 2020

(54) IMAGE PROCESSING APPARATUS, IMAGE PROCESSING METHOD, AND NON-TRANSITORY READABLE RECORDING MEDIUM STORING PROGRAM

(71) Applicant: TOYOTA JIDOSHA KABUSHIKI KAISHA, Toyota-shi (JP)

(72) Inventors: Yoshihiro OE, Kawasaki-shi (JP); Kazuya NISHIMURA, Okazaki-shi (JP); Hirofumi KAMIMARU, Fukuoka-shi (JP)

(73) Assignee: TOYOTA JIDOSHA KABUSHIKI KAISHA, Toyota-shi (JP)

(21) Appl. No.: 16/515,685

(22) Filed: Jul. 18, 2019

(30) Foreign Application Priority Data
Oct. 4, 2018 (JP) 2018-189499

(51) Int. Cl. G06T 7/00; G06K 9/00

(52) U.S. Cl. CPC G06T 7/0002; G06T 2207/30256; G06T 2207/30168; G06K 9/00798

(57) ABSTRACT

An image processing apparatus includes a memory configured to record base image data and an index value of the base image data, and a processor. The processor is configured to calculate an index value based on input image data and correct answer information at a position where the input image data is captured, read an index value of base image data at the position where the input image data is captured, from the memory, and write the input image data and the calculated index value into the memory such that each of the base image data and the index value of the base image data is updated in a case where the calculated index value has evaluation higher than evaluation of the index value of the base image data.

### INCORPORATION BY REFERENCE

The disclosure of Japanese Patent Application No. 2018-189499 filed on Oct. 4, 2018 including the specification, drawings and abstract is incorporated herein by reference in its entirety.

### BACKGROUND

### 1. Technical Field

The present disclosure relates to an image processing apparatus, an image processing method, and a non-transitory readable recording medium storing a program.

### 2. Description of Related Art

Japanese Unexamined Patent Application Publication No. 2014-056501 (JP 2014-056501 A) discloses a video processing apparatus including a weather variable information acquisition unit that acquires weather information indicating weather and weather degree information indicating the degree of the weather, and a shader controller that changes weather in a video based on the weather information. With the video processing apparatus, it is possible to generate an image for “rainy” or “snowy” weather based on an image for “fine” weather.

### SUMMARY

In the related art, the image used for “fine” weather is a base image used to generate images for other weathers. Thus, in a case where other images having different display contents are generated based on a base image, the quality of a generated image depends on the quality of the base image. Consequently, in a case where a base image has low image quality, there is a problem in that a generated image also has low image quality.

The present disclosure provides an image processing apparatus, an image processing method, and a non-transitory readable recording medium storing a program capable of improving the quality of a base image and thus improving the quality of an image generated based on the base image.

A first aspect of the present disclosure relates to an image processing apparatus including a memory and a processor. The memory is configured to record base image data and an index value of the base image data. The base image data is a base of new image data that is generated by the image processing apparatus. The processor is configured to calculate an index value based on input image data and correct answer information at a position where the input image data is captured, read the index value of the base image data at the position where the input image data is captured, from the memory, and write the input image data and the calculated index value into the memory such that each of the base image data and the index value of the base image data is updated in a case where the calculated index value has evaluation higher than evaluation of the index value of the base image data.

In the image processing apparatus according to the first aspect, the processor may be configured to calculate, as the index value, a recognition ratio of at least one of a graphic drawn on a road surface and an object provided on the road surface, included in the input image data, to at least one of information regarding a graphic drawn on a road surface and information regarding an object provided on the road surface, included in the correct answer information.

According to this aspect, since a recognition ratio in recognizing a graphic drawn on a road surface or an object provided on the road surface is used as an index value, a great index value has high evaluation, a more accurate index value can be calculated, and thus comparison between a calculated index value and an index value of base image data is facilitated.

In the image processing apparatus according to the first aspect, the processor may be configured to calculate a median of pixels of a road surface in the input image data, and calculate a difference between the median and an ideal pixel value included in the correct answer information as the index value.

According to this aspect, since a median of pixels of the road surface is calculated, and a difference between the median and an ideal pixel value is used as the index value, a small index value has high evaluation, a more accurate index value can be calculated, and thus comparison between a calculated index value and an index value of base image data is facilitated.

In the image processing apparatus according to the first aspect, the processor may be configured to read weather information at the same position as the position where the input image data is captured, and compare the calculated index value with the index value of the base image data in a case where weather included in the weather information is predetermined weather.

According to this, since the index value of the input image data is compared with the index value of the base image data in a case where weather is restricted to predetermined weather, for example, weather appropriate to capture an image is selected as the predetermined weather, and thus the reliability of an index value is improved such that it is possible to improve the reliability in an index value comparison process.

A second aspect of the present disclosure relates to an image processing method executed by an image processing apparatus. The image processing apparatus includes a memory and a processor. The image processing method includes calculating an index value based on input image data and correct answer information at a position where the input image data is captured; reading an index value of base image data at the position where the input image data is captured, from the memory, the base image data being a base of new image data that is generated by the image processing apparatus; and writing the input image data and the calculated index value into the memory such that each of the base image data and the index value of the base image data is updated in a case where the calculated index value has evaluation higher than evaluation of the index value of the base image data.

A third aspect of the present disclosure relates to a non-transitory readable recording medium storing a program causing a processor to execute a control method for an image processing apparatus including the processor and a memory. The program causes the processor to execute a control process for the image processing apparatus. The control process includes calculating an index value based on input image data and correct answer information at a position where the input image data is captured; reading an index value of base image data at the position where the input image data is captured, from the memory, the base image data being a base of new image data that is generated by the image processing apparatus; and writing the input image data and the calculated index value into the memory such that each of the base image data and the index value of the base image data is updated in a case where the calculated index value has evaluation higher than evaluation of the index value of the base image data.

According to the aspects of the present disclosure, in a case where an index value of input image data has evaluation higher than that of an index value of base image data captured in the past, the base image data is updated to the input image data. Therefore, it is possible to improve the quality of base image data and thus to improve the quality of image data generated based on the base image data.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a block diagram illustrating an image update system to which an image processing apparatus according to a first embodiment is applicable;

FIG. 2 is a flowchart for describing an image processing method according to the first embodiment;

FIG. 3 is a diagram for describing an example of a method of calculating an index value of an image according to the first embodiment;

FIG. 4 is a flowchart for describing an image generation method based on the image processing method of the first embodiment;

FIG. 5 is a schematic diagram for describing the image generation method based on the image processing method of the first embodiment;

FIG. 6 is a block diagram illustrating a configuration of a vehicle according to a second embodiment; and

FIG. 7 is a flowchart for describing an image processing method according to the second embodiment.

### DETAILED DESCRIPTION OF EMBODIMENTS

### First Embodiment

Image Processing System

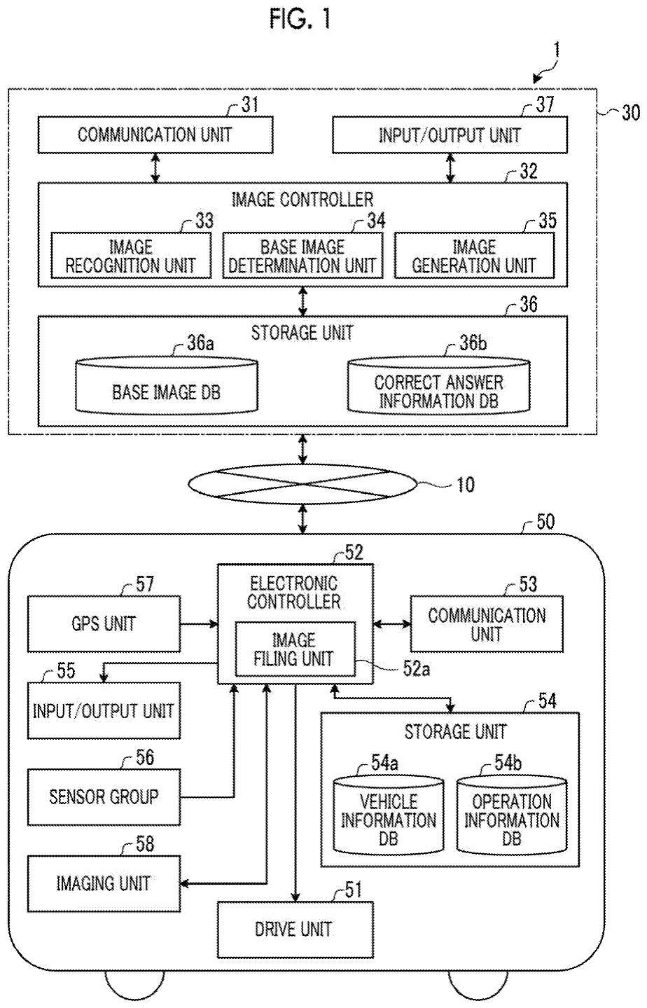

First, a description will be made of an image processing system to which an image processing apparatus according to a first embodiment is applicable. FIG. 1 illustrates an image processing system 1 to which the image processing apparatus according to the first embodiment is applicable. As illustrated in FIG. 1, the image processing system 1 according to the embodiment includes an image processing server 30 and a vehicle 50 which can perform communication with each other via a network 10. The network 10 may be the Internet or a mobile phone network. The network 10 is, for example, a public communication network such as the Internet, and may include a wide area network (WAN), a telephone communication network for a mobile phone or the like, or other communication networks such as a wireless communication network, for example, Wi-Fi.

Image Processing Server

The image processing server 30 as an image processing apparatus processes image information transmitted from the vehicle 50. The image information includes image data, and information regarding an imaging position of the image data and an imaging time of the image data. The image data may be still image data, and may be moving image data, and moving images may be generated by using a plurality of pieces of temporally consecutive still image data. In the first embodiment, various pieces of vehicle information are transmitted to the image processing server 30 from each vehicle 50 at a predetermined timing. The vehicle information includes position information, and may further include information regarding situations of the vehicle 50 such as a state of charge (SOC), a residual fuel quantity, and an in-vehicle status.

The image processing server 30 has a configuration of a general computer which can perform communication via the network 10. The image processing server 30 includes a communication unit 31, an image controller 32, a storage unit 36 storing a base image database 36a therein, and an input/output unit 37. The communication unit 31 is, for example, a local area network (LAN) interface board, or a wireless communication circuit performing wireless communication. The LAN interface board or the wireless communication circuit is connected to the network 10 such as the Internet that is a public communication network. The communication unit 31 is connected to the network 10, and performs communication with the vehicle 50. The communication unit 31 receives vehicle identification information or vehicle information specific to each vehicle 50 from the vehicle 50, or transmits an instruction signal to the vehicle 50. The vehicle identification information includes information for enabling each vehicle 50 to be individually identified.

The image controller 32 includes, for example, a processor such as a central processing unit (CPU), a digital signal processor (DSP), or a field programmable gate array (FPGA), and a main storage unit such as a random access memory (RAM) or a read only memory (ROM) (none illustrated). The storage unit 36 is configured to include a storage medium selected from among an erasable programmable ROM (EPROM), a hard disk drive (HDD), and a remote medium. The remote medium is, for example, a Universal Serial Bus (USB) memory or a memory card, or a disc recording medium such as a compact disc (CD), a digital versatile disc (DVD), or a Blu-ray (registered trademark) disc (BD). The storage unit 36 stores an operating system (OS), various programs, various tables, various databases, and the like.

The storage unit 36 includes the base image database 36a in which a plurality of pieces of base image data is stored to be retrievable, and a correct answer information database 36b. The base image database 36a is, for example, a relational database (RDB) in which image data is stored to be retrievable. Base image data and image incidental information of the base image data are associated with each other, and are stored to be retrievable in the base image database 36a. The image incidental information is, for example, image position information indicating longitude and latitude of an imaging position of the base image data, imaging time information of the base image data, and an index value of a base image. The correct answer information database 36b is a database in which correct answer information used as a criterion for determining input image data is stored in association with position information. The correct answer information stored in the correct answer information database 36b is stored as various pieces of information such as map information or image data. Map information or image data is collected from external devices by the image controller 32 via the network 10, or is input from the input/output unit 37 by a worker, to be stored as the correct answer information in the correct answer information database 36b. A method of collecting correct answer information is not limited to the above-described method. Here, the database (DB) is built by a program of a database management system (DBMS) executed by the processor managing data stored in the storage unit 36.

The image controller 32 may load a program stored in the storage unit 36 to a work area of the main storage unit, execute the program, and control each constituent element through execution of the program, so as to realize a function matching a predetermined purpose. In the present embodiment, the image controller 32 may realize functions of an image recognition unit 33, a base image determination unit 34, and an image generation unit 35 through execution of the program.

The image recognition unit 33 executes a recognition process on base image data received from the predetermined vehicle 50, so as to calculate an index value. The base image determination unit 34 compares the index value of the base image data having undergone the recognition process in the image recognition unit 33 with an index value of base image data stored in the base image database 36a of the storage unit 36, and determines which index value has higher evaluation. Details of an index value of a base image and the degree of evaluation will be described later. The image generation unit 35 performs image processing on a base image stored in the base image database 36a, so as to generate another piece of image data based on base image data. Another piece of image data is image data generated by superimposing, on the base image data, an image for weather or a time point that is different from weather or a time point at the time of capturing the base image data. The input/output unit 37 as output means displays the image data generated by the image generation unit 35 on a display screen of, for example, a liquid crystal display or an organic EL display under the control of the image controller 32.

The input/output unit 37 displays text, graphics, or the like on a screen of a touch panel display under the control of the image controller 32, so as to notify an external device of predetermined information. In the input/output unit 37, sounds may be output from a speaker microphone. The input/output unit 37 as input means is configured to include a keyboard, a switch, a touch panel display, or a speaker microphone. For example, a user or the like may operate the touch panel display or generate a voice toward the speaker microphone, and thus the input/output unit 37 may input predetermined information to the image controller 32.

Vehicle

The vehicle 50 as a moving object is a vehicle which travels due to driver's driving or an autonomous traveling vehicle which can autonomously travel according to a given operation command. The vehicle 50 includes a drive unit 51, an electronic controller 52, a communication unit 53, a storage unit 54, an input/output unit 55, a sensor group 56, a global positioning system (GPS) unit 57, and an imaging unit 58.

The drive unit 51 is used to cause the vehicle 50 to travel. Specifically, the vehicle 50 is provided with an engine as a drive source, and the engine is configured to be able to generate electric power by using an electric motor or the like through drive caused by combustion of a fuel. The generated electric power charges a chargeable battery. The vehicle 50 includes a drive transmission mechanism transmitting drive force of the engine, drive wheels used for the vehicle to travel, and the like.

The electronic controller 52 and the storage unit 54 are respectively physically the same as the image controller 32 and the storage unit 36. The electronic controller 52 collectively controls operations of various constituent elements mounted on the vehicle 50. The communication unit 53 is, for example, a data communication module (DCM) which performs communication with the image processing server 30 through wireless communication using the network 10. An image filing unit 52a of the electronic controller 52 files image data captured by the imaging unit 58 as image information, and transmits the image information to the image processing server 30 via the communication unit 53. The storage unit 54 includes a vehicle information database 54a and an operation information database 54b. Various pieces of information including a state of charge, a residual fuel quantity, and a current position are stored to be updatable in the vehicle information database 54a. Various pieces of data including operation information provided to, for example, an operation management server (not illustrated) are stored to be updatable in the operation information database 54b. The input/output unit 55 is physically the same as the input/output unit 37.

The sensor group 56 includes sensors regarding traveling of the vehicle 50, such as a vehicle speed sensor and an acceleration sensor, and, for example, vehicle cabin sensors which can sense various situations of a vehicle cabin. The GPS unit 57 receives a radio wave from a GPS satellite (not illustrated), and detects a position of the vehicle 50. The detected position is stored to be retrievable in the vehicle information database 54a as position information in the vehicle information. As a method of detecting a position of the vehicle 50, a method in which Light Detection and Ranging or Laser Imaging Detection and Ranging (LiDAR) is combined with a three-dimensional digital map may be employed. The imaging unit 58 is, for example, an imaging device such as an imaging camera, and inputs captured image data to the electronic controller 52.

Image Processing Method

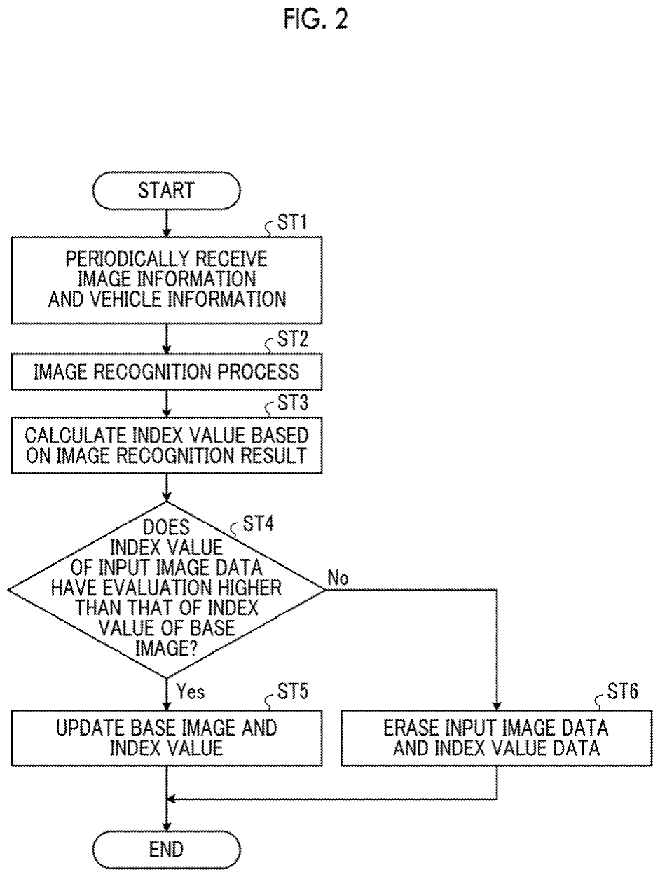

Next, a description will be made of an image processing method executed in the image processing system 1 having the above-described configuration. In the following description, transmission and reception of information are performed via the network 10, but descriptions thereof will be omitted. FIG. 2 is a flowchart for describing an image processing method according to the first embodiment.

In other words, as shown in step ST1 in FIG. 2, the image processing server 30 periodically receives image information including image data and vehicle information from each vehicle 50. The vehicle information is periodically transmitted at a predetermined timing from the communication unit 53 under the control of the electronic controller 52 of the vehicle 50. The image information is information obtained by filing image data and image incidental information in the image filing unit 52a of the electronic controller 52, and is periodically transmitted from the communication unit 53 at a predetermined timing. Here, as the predetermined timing, for example, various timings in the vehicle 50 such as a periodic timing at a predetermined time interval or a timing at which the vehicle 50 passes a predetermined position may be set. The image data included in the image information is at least one of still image data and moving image data captured by the imaging unit 58 of the vehicle 50.

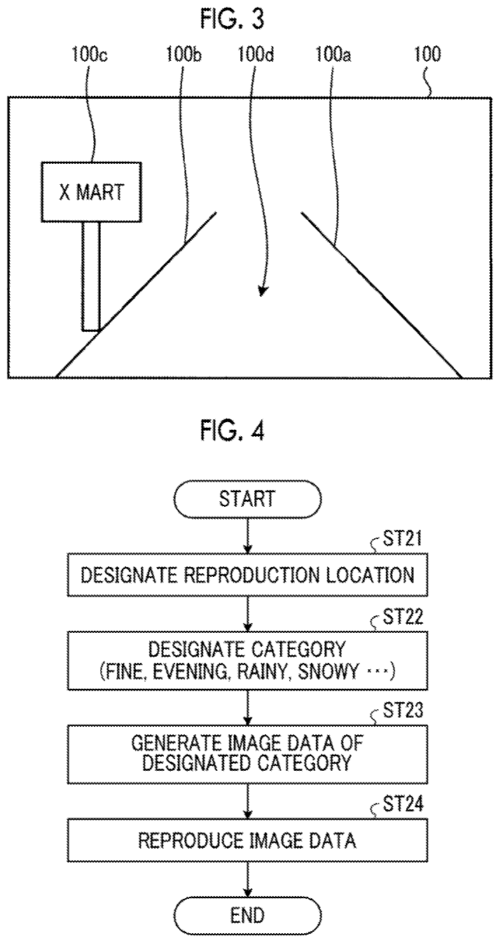

Next, in step ST2, the image recognition unit 33 of the image processing server 30 having received the image information performs an image recognition process on the image data (hereinafter, referred to as “input image data”) included in the image information received by the image processing server 30. FIG. 3 is a schematic diagram for describing an image recognition processing method, and illustrates an example of input image data captured by the imaging unit 58 of the vehicle 50.

As illustrated in FIG. 3, for example, two white lines 100a, 100b drawn on a road surface, and an object 100c such as a signboard provided on the road surface are captured in input image data 100. The image recognition unit 33 recognizes imaged states of the white lines 100a, 100b, specifically, for example, coordinate information of the white lines 100a, 100b in the input image data 100. Similarly, the image recognition unit 33 recognizes coordinate information of the object 100c in the input image data 100.

The image recognition unit 33 reads correct answer information based on position information in the input image data 100 from the correct answer information database 36b. The correct answer information includes coordinate information in correct states of the white lines 100a, 100b drawn on the road surface and the object 100c at a location corresponding to the position information in the input image data 100. The image recognition unit 33 compares the coordinate information of the white lines 100a, 100b in the read correct answer information with the coordinate information of the white lines 100a, 100b recognized in the input image data 100. The image recognition unit 33 compares the coordinate information of the object 100c in the read correct answer information with the coordinate information of the object 100c recognized in the input image data 100.

In step ST3, the image recognition unit 33 calculates a recognition ratio based on a comparison result between the coordinate information of the white lines 100a, 100b and the object 100c in the image data and the coordinate information of the white lines 100a, 100b and the object 100c in the correct answer information. For example, in a case where a recognition result of the image data substantially matches the correct answer information with respect to the coordinate information of the white line 100a and the object 100c, and a recognition result of the image data is different from the correct answer information with respect to the coordinate information of the white line 100b, a recognition ratio is calculated to be about 2/3, that is, 67%. The image recognition unit 33 sets the recognition ratio as an index value, and outputs the index value to the base image determination unit 34.

Next, the flow proceeds to step ST4, and the base image determination unit 34 reads an index value of corresponding base image data at the same position as that in the input image data 100 from the base image database 36a. The base image determination unit 34 determines whether or not the index value of the input image data 100 has evaluation higher than that of the index value of the base image data read from the base image database 36a. Here, in a case where a recognition ratio is used as an index value, a recognition ratio becomes higher and the quality of image data becomes higher as the index value becomes greater, and thus high evaluation is given. In this case, the base image determination unit 34 determines whether or not the index value of the input image data 100 is greater than the index value of the base image data read from the base image database 36a.

In a case where the base image determination unit 34 determines that the index value of the input image data 100 is greater than the index value of the base image data read from the base image database 36a (step ST4: Yes), the flow proceeds to step ST5. In step ST5, the base image determination unit 34 stores the input image data 100 in the base image database 36a in association with data regarding the index value of the input image data 100 calculated by the image recognition unit 33, and thus updates a base image and an index value. Thus, the base image update process based on the image processing method of the first embodiment is finished.

In a case where the base image determination unit 34 determines that the index value of the input image data 100 is equal to or smaller than the index value of the base image data read from the base image database 36a (step ST4: No), the flow proceeds to step ST6. In step ST6, the base image determination unit 34 erases the input image data 100 and the data regarding the index value. In this case, a base image is not updated, and the image processing is finished.

Modification Example of Calculation of Index Value

Here, a description will be made of a modification example of image processing in the above steps ST2 to ST4. As illustrated in FIG. 3, for example, an asphalt road 100d is captured in the input image data 100. Here, as a process corresponding to step ST2, the image recognition unit 33 performs an image recognition process on an asphalt portion of the road 100d in the input image data 100, and thus calculates a median of pixel values of the asphalt portion. On the other hand, as a process corresponding to step ST3, the image recognition unit 33 reads an ideal pixel value of the median of the pixel values of the asphalt portion from the correct answer information database 36b based on position information in the input image data 100. The image recognition unit 33 calculates a difference between the read ideal pixel value in correct answer information and the median of the pixel values calculated through the recognition process. The image recognition unit 33 sets the calculated difference as an index value, and outputs the index value to the base image determination unit 34.

The base image determination unit 34 having received the index value reads an index value of corresponding base image data at the same position as that in the input image data 100 from the base image database 36a. The base image determination unit 34 determines whether or not the index value of the input image data 100 has evaluation higher than that of the index value of the base image data read from the base image database 36a. Here, in a case where the difference between a median of pixel value and an ideal pixel value is used as an index value, the median of the pixel values and the ideal pixel value comes closer to each other and the quality of image data becomes higher as the index value becomes smaller, and thus high evaluation is given. In this case, the base image determination unit 34 determines whether or not the index value of the input image data 100 is smaller than the index value of the base image data read from the base image database 36a.

In a case where the base image determination unit 34 determines that the index value of the input image data 100 is smaller than the index value of the base image data read from the base image database 36a (step ST4: Yes), the flow proceeds to step ST5. On the other hand, in a case where the base image determination unit 34 determines that the index value of the input image data 100 is equal to or greater than the index value of the base image data read from the base image database 36a (step ST4: No), the flow proceeds to step ST6. The rest image processing methods are the same as in the first embodiment.

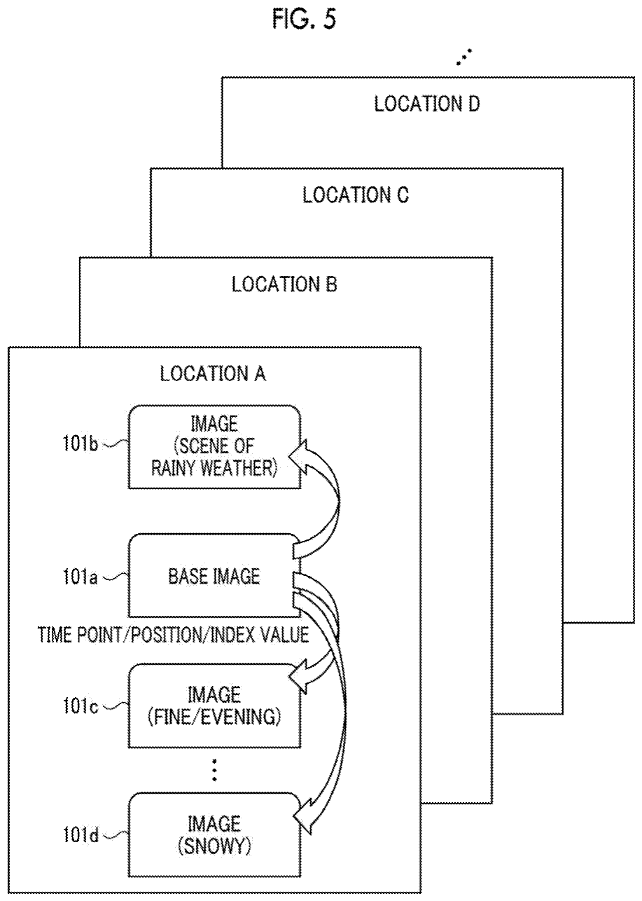

In the above-described way, pieces of base image data at various locations are updated and accumulated in the base image database 36a. The image generation unit 35 may generate images corresponding to imaging environments or temporal changes at various captured locations based on the base image data accumulated in the base image database 36a. FIGS. 4 and 5 are respectively a flowchart and a schematic diagram for describing an image generation method based on the image processing method of the first embodiment. The following description will be made according to the flowchart of FIG. 4 while referring to FIG. 5 as appropriate.

As illustrated in FIG. 4, in step ST21, position information of a location at which an image is desired to be reproduced is input to the image processing server 30 via the network 10 from an external device or is input from the input/output unit 37. The input position information is input to the image generation unit 35 of the image controller 32. In step ST22, information regarding a category corresponding to a situation in which an image is desired to be reproduced is input to the image processing server 30 via the network 10 from an external device or is input from the input/output unit 37. As illustrated in FIG. 5, a designated category is, for example, an image 101b for rainy weather, an image 101c for the evening in fine weather, or an image 101d for snowy weather. Subsequently, in step ST23 in FIG. 4, the image generation unit 35 generates image data of the designated category based on a base image 101a through, for example, image style conversion using a deep neural network or image generation using a generative adversarial network (GAN). As described above, the base image 101a is associated with image incidental information such as time information at which the base image 101a is captured, position information, and an index value. The image generation unit 35 outputs the generated image data to the input/output unit 37, or transmits the image data to an external display device (not illustrated) via the network 10. In step ST24, the input/output unit 37 or the display device to which the image data is input reproduces the input image data. The image generation process may be executed for each location A, B, C, D, . . . . Consequently, the image generation unit 35 may generate and reproduce pieces of image data in various situations based on a base image and information regarding a designated category for each location A, B, C, D, . . . . Thus, it is possible to provide images for environments which look different from each other and to reproduce the images on a display device.

According to the first embodiment of the present disclosure described above, in a case where an index value of new image data captured by the imaging unit 58 of the vehicle 50 has evaluation higher than that of an index value of base image data stored in the image processing server 30 and captured in the past through a base image determination process, the base image data captured in the past is updated to a new image. Consequently, the quality of a base image can be improved, and thus qualities of other images generated based on the base image can be improved. Since solely a base image corresponding to a fundamental image is updated, and other images in which environments at a certain location look different from each other are generated based on the base image, it is not necessary to accumulate all pieces of image data for each environment in the storage unit 36. Therefore, it is possible to reduce a capacity of the storage unit 36 and thus to reduce operation cost.

### Second Embodiment

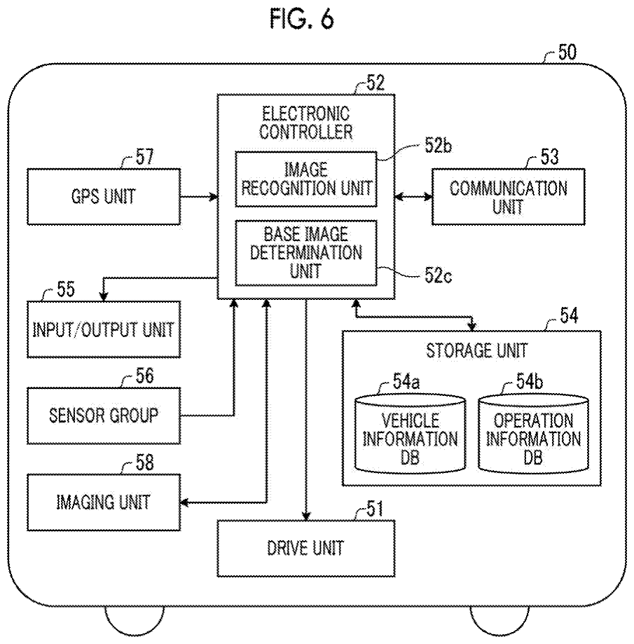

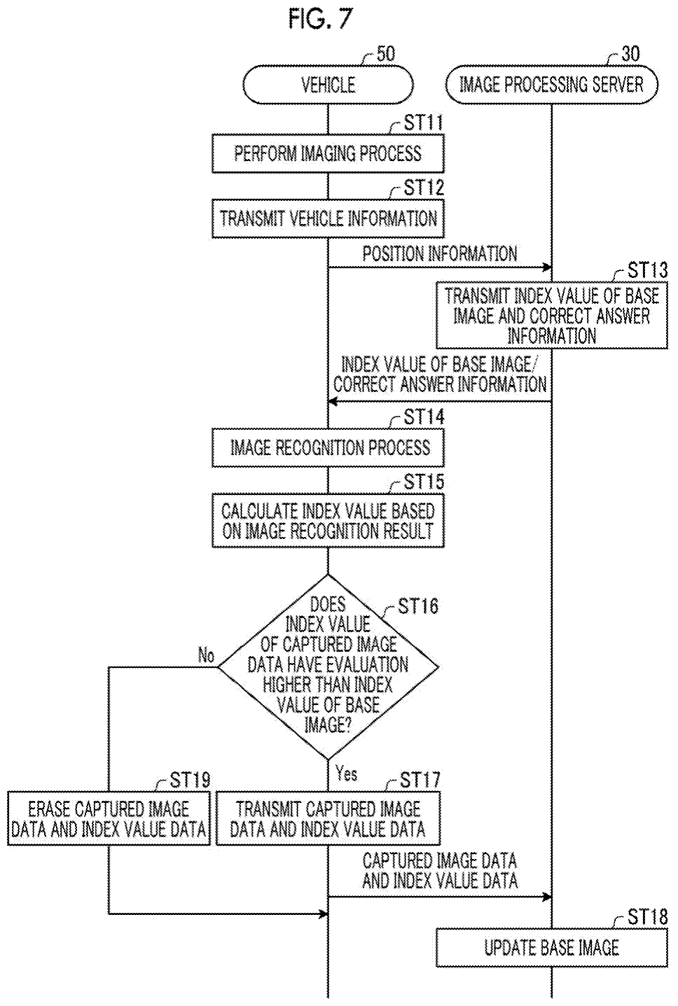

Next, a description will be made of an image processing system and an image processing method according to a second embodiment. FIG. 6 is a block diagram illustrating a configuration of a vehicle 50 according to the second embodiment. FIG. 7 is a flowchart for describing an image processing method according to the second embodiment.

As illustrated in FIG. 6, in the second embodiment, the electronic controller 52 of the vehicle 50 includes an image recognition unit 52b and a base image determination unit 52c. The image recognition unit 52b and the base image determination unit 52c are respectively the same as the image recognition unit 33 and the base image determination unit 34 of the image controller 32 in the image processing server 30 according to the first embodiment.

As illustrated in FIG. 7, first, in step ST11, the imaging unit 58 performs imaging while the vehicle 50 is at a standstill or is traveling. Captured image data obtained through imaging in the imaging unit 58 is, for example, image data illustrated in FIG. 3. Next, in step ST12, the vehicle 50 transmits vehicle information including position information of the captured image data to the image processing server 30. In step ST13, the image processing server 30 transmits an index value of base image data at the received position information and correct answer information regarding a location corresponding to the received position information, to the vehicle 50.

Subsequently, in steps ST14 and ST15, the image recognition unit 52b of the vehicle 50 performs an image recognition process based on the received correct answer information on the captured image data in the same manner as in steps ST2 and ST3 described above, so as to calculate an index value. Thereafter, in step ST16, the base image determination unit 52c compares the calculated index value with the index value of the received base image data in the same manner as in step ST4 described above.

In step ST16, the base image determination unit 52c determines whether or not the index value of the captured image data has evaluation higher than that of the index value of the received base image data. Here, as an index value of base image data or captured image data, the above-described recognition ratio may be used, or the above-described difference between a median of pixel values and an ideal pixel value may be used. In a case where the base image determination unit 52c determines that the index value of the captured image data has evaluation higher than that of the index value of the base image data (step ST16: Yes), the flow proceeds to step ST17.

In step ST17, the base image determination unit 52c associates the captured image data with data regarding the index value of the captured image data calculated by the image recognition unit 52b, and transmits an associated result to the image processing server 30. In step ST18, the image processing server 30 stores the received captured image data and data regarding the index value in the base image database 36a as new base image data, and thus updates a base image and an index value. Thus, the base image update process based on the image processing method of the second embodiment is finished.

In a case where the base image determination unit 52c determines that the index value of the captured image data has evaluation equal to or lower than that of the index value of the received base image data (step ST16: No), the flow proceeds to step ST19. In step ST19, the base image determination unit 52c erases the captured image data and the data regarding the index value. In this case, the captured image data is not transmitted from the vehicle 50, and image processing is finished.

In the second embodiment described above, an image recognition process and a base image determination process are executed in the vehicle 50, and thus the same effect as that in the first embodiment can be achieved. According to the second embodiment, an index value of captured image data is compared with an index value of base image data stored in the image processing server 30 before the captured image data obtained through imaging in the imaging unit 58 of the vehicle 50 is transmitted. Consequently, in a case where the index value of the captured image data has evaluation equal to or lower than that of the index value of the base image data, it is not necessary to transmit a large volume of image data from the communication unit 53. Therefore, it is possible to reduce a communication capacity of the vehicle 50 and thus to reduce cost needed in communication.

Recording Medium

In the above-described embodiments, a program enabling the image processing method to be executed may be recorded on a recording medium that is readable by a computer or other machines or devices (hereinafter, referred to as a “computer or the like”). The computer or the like reads the program recorded on the recording medium and executes the program, and thus the computer functions as the image processing server 30 of the first embodiment or the electronic controller 52 of the vehicle 50 of the second embodiment. Here, the recording medium that is readable by the computer or the like indicates a non-transitory recording medium in which information such as data or a program is accumulated through electrical, magnetic, optical, mechanical, or chemical action and from which the information can be read by the computer or the like. Among such recording media, examples of a recording medium that is detachable from the computer or the like include a flexible disk, a magneto-optical disc, a CD-ROM, a compact disc-rewritable (CD-R/W), a DVD, a BD, a digital audio tape (DAT), a magnetic tape, and a memory card such as a flash memory. Examples of a recording medium fixed to the computer or the like include a hard disk and a ROM. A solid state drive (SSD) may be used as a recording medium detachable from the computer or the like, and may be used as a recording medium fixed to the computer or the like.

Further effects or modification examples may be easily derived by a person skilled in the art. An applicable embodiment of the present disclosure is not limited to the specific details and the representative embodiments which have been represented and described as mentioned above. Therefore, the present disclosure may be variously modified without departing from the spirit of the scope of the concept of the present disclosure.

For example, the configuration of the server or the type of information described in the above-described embodiments is merely an example, and a configuration of the server or the type of information that is different from that in the above example may be employed as necessary.

For example, in the above-described embodiments, any one of the respective functional constituent elements of the image processing server 30 or some processes therein may be executed by another computer connected to the network 10. A series of processes executed by the image processing server 30 may be executed by hardware, and may be executed by software.

For example, in the first embodiment described above, the image processing server 30 is a single server, but the image processing server 30 may be configured to include a plurality of separate servers which can perform communication with each other. Specifically, for example, the storage unit 36 of the image processing server 30 may be provided in another data server which can perform transmission and reception of information via the network 10. The base image database 36a and the correct answer information database 36b in the storage unit 36 of the image processing server 30 may be respectively stored in different data servers. The image processing server 30 may store various pieces of image data collected in the past via the network 10 as a database including, for example, big data.

For example, in the first embodiment and Modification Example 1 described above, there may be a configuration in which the base image determination unit 34 receives weather information via the network 10, and the determination in step ST4 is performed in a case where the weather information indicates predetermined weather, for example, fine weather.

What is claimed is:

1. An image processing apparatus comprising:
a memory configured to record base image data and an index value of the base image data, the base image data being a base of new image data that is generated by the image processing apparatus; and
a processor configured to
calculate an index value based on input image data and correct answer information at a position where the input image data is captured,
read the index value of the base image data at the position where the input image data is captured, from the memory, and
write the input image data and the calculated index value into the memory such that each of the base image data and the index value of the base image data is updated in a case where the calculated index value has evaluation higher than evaluation of the index value of the base image data.

2. The image processing apparatus according to claim 1, wherein the processor is configured to calculate, as the index value, a recognition ratio of at least one of a graphic drawn on a road surface and an object provided on the road surface, included in the input image data, to at least one of information regarding a graphic drawn on a road surface and information regarding an object provided on the road surface, included in the correct answer information.

3. The image processing apparatus according to claim 1, wherein the processor is configured to calculate a median of pixels of a road surface in the input image data, and calculate a difference between the median and an ideal pixel value included in the correct answer information as the index value.

4. The image processing apparatus according to claim 2, wherein the processor is configured to read weather information at the same position as the position where the input image data is captured, and compare the calculated index value with the index value of the base image data in a case where weather included in the weather information is predetermined weather.

5. An image processing method executed by an image processing apparatus including a memory and a processor, the image processing method comprising:
calculating an index value based on input image data and correct answer information at a position where the input image data is captured;
reading an index value of base image data at the position where the input image data is captured, from the memory, the base image data being a base of new image data that is generated by the image processing apparatus; and
writing the input image data and the calculated index value into the memory such that each of the base image data and the index value of the base image data is updated in a case where the calculated index value has evaluation higher than evaluation of the index value of the base image data.

6. A non-transitory readable recording medium storing a program causing a processor to execute a control method for an image processing apparatus including the processor and a memory, the program causing the processor to execute a control process for the image processing apparatus, the control process comprising:
calculating an index value based on input image data and correct answer information at a position where the input image data is captured;
reading an index value of base image data at the position where the input image data is captured, from the memory, the base image data being a base of new image data that is generated by the image processing apparatus; and
writing the input image data and the calculated index value into the memory such that each of the base image data and the index value of the base image data is updated in a case where the calculated index value has evaluation higher than evaluation of the index value of the base image data.
